(19) United States
(12) Patent Application Publication
(10) Pub. No.: US 2005/0061092 A1
(43) Pub. Date: Mar. 24, 2005

(54) Modular motion unit with tensioner

(75) Inventor: Mark S. Meier, Encinitas, CA (US)

Correspondence Address: WOOD, HERRON & EVANS, LLP (NORDSON), 2700 CAREW TOWER, 441 VINE STREET, CINCINNATI, OH, 45202, US

(73) Assignee: Nordson Corporation, Westlake, OH (US)

(21) Appl. No.: 10/823,174

(22) Filed: Apr. 13, 2004

Related U.S. Application Data
(60) Provisional application No. 60/504,584, filed on Sep. 19, 2003.

(51) Int. Cl. F16H 31/00

(52) U.S. Cl. 74/89.22

(57) ABSTRACT

A precision positioning device, such as a robot, decouples the different axes of motion by utilizing a modular motion unit for each different axis of motion. Each modular motion unit includes a base structure, a linear guide, a carriage, a drive motor, and a cable to convert the torque of the drive motor into useful, controlled carriage movement. The parts and sub-assemblies of each modular motion unit are interchangeable without concern about the ultimate orientation of the unit. To assemble the units into a robot, the modular motion units are attached to an underlying frame structure to provide computer-controlled movement over a designated physical work space. Re-tensioning of a drive cable within the modular motion unit is accomplished without requiring the operator to have special training or tools. One end of the drive cable is attached to a tensioner that is releasably locked into place. When the tensioner is released, a spring operates to move the tensioner, and the cable, to a properly tensioned position.

### CROSS REFERENCE TO RELATED APPLICATIONS

This application claims the benefit of U.S. Provisional Application No. 60/504,584, filed Sep. 19, 2003, the disclosure of which is hereby incorporated by reference herein in its entirety.

### FIELD OF THE INVENTION

This invention relates generally to precision positioners and, more particularly, to computer controlled positioning tables.

### BACKGROUND OF THE INVENTION

Robots that move in the X, Y and Z axes are used in many technological fields to automate repetitive tasks, like those encountered on a production line. One particular type of robot, or precision positioning unit, of this nature involves a carriage that moves in a linear fashion over a range of positions under control of a computer. Conventionally, these robots include, for each axis of motion, a linear guide on a base structure that is interconnected with base structures for the other axes. A respective drive unit, such as a chain, belt, gear, ball screw or lead screw moves the carriage along the linear guide in a particular axis of motion. The connections between the base structures for each axis of motion can range from rails that connect to, or physically support, one another to even the sharing of drive components such as belts, cables and gears. These robots typically include a tool that is attached to perform a production-line function such as welding, soldering, gluing, heating, or dispensing material.

Because the base structures are integrated with one another, the design and operation of one base structure (e.g., the X-axis) is dependent on the size and other physical characteristics of the other base structures (e.g., the Y-axis). Accordingly, even though the linear guides, the base structures, and other parts serve similar functions for each axis of motion, they are not interchangeable. This can increase design complexity and costs. Additionally, it can be very difficult to change the robot's range of motion and range of travel without redesigning and rebuilding the entire robot.

### SUMMARY OF THE INVENTION

Embodiments of the present invention address these and other problems of the prior art by providing a modular motion unit that can be readily designed and built without concern about its intended axis-of-movement direction.

One aspect of the present invention relates to a cable-drive modular motion unit for one axis of motion in a positioning device which includes a base structure and a linear guide attached with the base structure, wherein the linear guide has a major axis aligned with the one axis of motion. Also included is a carriage arranged on the linear guide such that motion of the carriage is limited to being along the major axis. The cable-drive is effected by a drive motor attached to the base structure, and a cable attached to the carriage and the drive motor such that rotation of the drive motor causes movement of the carriage, but, during operation of the positioning device, the cable is not connected to any portion of the positioning device that moves in another axis of motion.

Another aspect of the invention relates to a modular motion unit usable along any axis of motion in a positioning device that includes a base structure; a linear guide attached to the base structure and having a major axis; and a carriage arranged on the linear guide such that motion of the carriage is limited to being along the major axis. Also included are a drive motor attached to the base structure and a cable attached to the carriage and the drive motor such that rotation of the drive motor causes movement of the carriage. During operation of the positioning device, the modular motion unit is attached to a frame member of the positioning device such that the major axis is aligned with an intended axis of motion.

A further aspect of the invention relates to a positioning device that includes a first and a second modular motion unit that include, respectively, a base structure and a linear guide attached to the base structure having a major axis aligned with one axis of motion. The positioning device further includes a carriage arranged on the linear guide such that motion of the carriage is limited to being along the major axis. Also, a drive motor is attached to the base structure and a cable is attached to the carriage and the drive motor such that rotation of the drive motor causes movement of the carriage. During operation of the positioning device, the first and second modular motion units are unconnected to one another. As a result, the modular motion units described above may be aligned along any desired axis of motion independent of other modular motion units. This allows parts and pieces of the modular motion units to be generic to any axis of motion. Therefore, manufacturing processes may be uniform for all motion units without regard for their intend use and the amount of different parts in inventory may be reduced. Additionally, re-sizing of a robot incorporating multiple modular motion units is simplified. Instead of re-engineering a complex two-dimensional motion unit, the present modular motion unit need only be re-sized in one dimension to change the range of motion for a robot.

Yet another aspect of the present invention relates to a tensioning device for a cable of a cable drive system. According to this aspect, the tensioning device includes a linear channel along which a tensioner plate can move, wherein the tensioner plate is attached with one end of the cable and movement of the tensioner plate in a first direction increases tension on the cable and movement of the tensioner plate in a second direction decreases tension on the cable. Also, a spring is included having a first fixed end and a second end operationally coupled with the tensioner plate; in particular, the spring is compressed so as to exert a force in the first direction. A releasable lock is attached to the tensioner plate and configured, in a first position, to prevent the tensioner plate from moving and, in a second position, permit the tensioner plate to move; whereby when the releasable lock is in the second position, the spring effects movement of the tensioner plate in the first direction. Accordingly, a conventional (rather than a specialized) tool may be employed to retention the cable and such an operation would not require a technician have specialized training.

Various additional advantages and features of the invention will become more apparent upon review of the following detailed description of the preferred embodiments of the invention taken in conjunction with the accompanying drawings.

### BRIEF DESCRIPTION OF THE DRAWINGS

FIG. 1 is a perspective view of a precision positioner having three modular motion units.

FIG. 2 is a perspective view of the three modular motion units of FIG. 1 without depicting the framework of the positioner.

FIG. 3 is a top perspective view of an exemplary modular motion unit.

FIG. 4 is a bottom perspective view of an exemplary modular motion unit.

FIG. 5 is a perspective view of a tensioner according to the present invention.

FIG. 6 top perspective view of another exemplary modular motion unit.

FIG. 7 is a bottom perspective view of another exemplary modular motion unit.

### DETAILED DESCRIPTION OF THE INVENTION

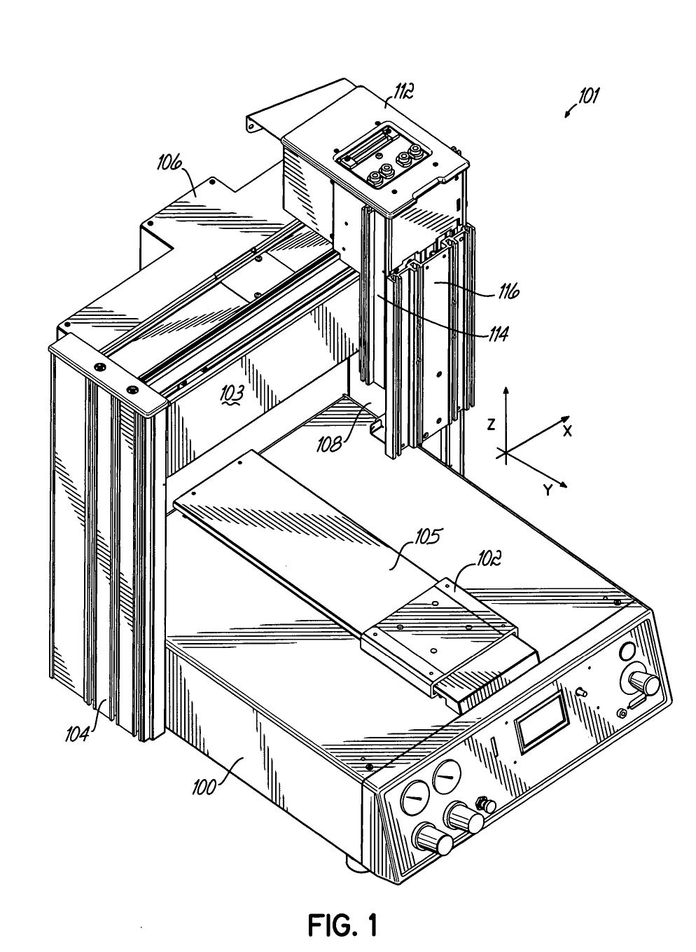

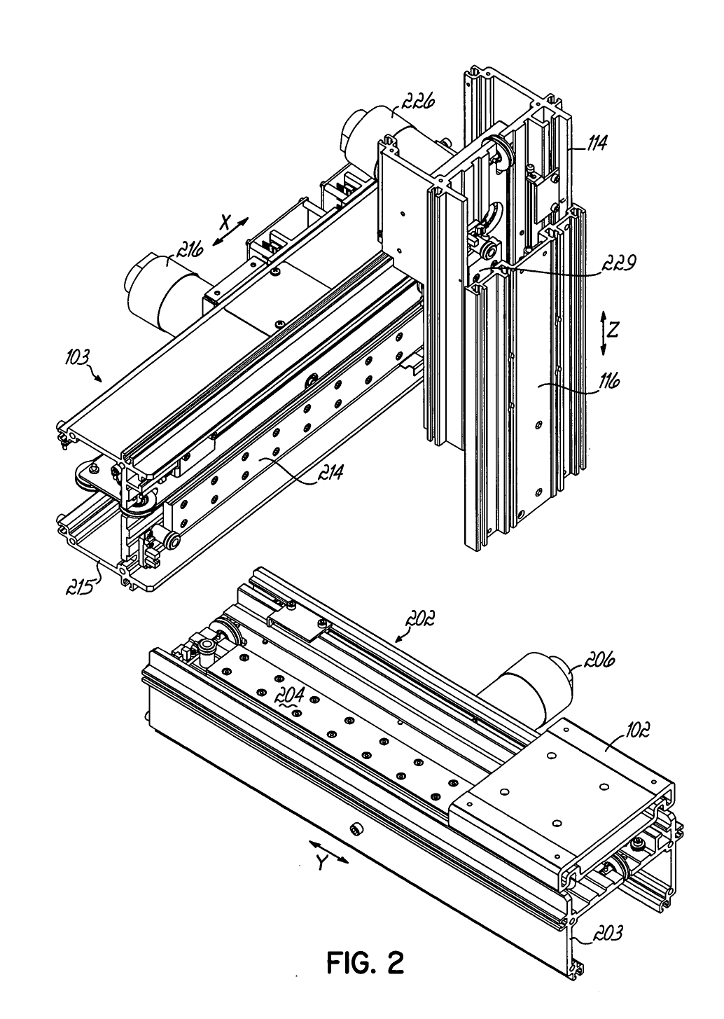

FIG. 1 illustrates a positioner unit, or robot, that includes three modular motion units assembled on a frame. FIG. 2 illustrates the same arrangement of the modular motion units without the frame structure being depicted. While precision positioner units of various sizes and capabilities are contemplated by the present invention, one exemplary positioner unit operates at acceleration forces of approximately ¼ g, provides positional accuracy to about 5 mils and positional repeatability of about 2 mils.

Referring to FIGS. 1 and 2, the positioner unit 101 includes a base 100, that in this instance houses the computer control assemblies and other electronic circuitry of the robot. With respect to the modular motion units, the base 100 provides a place to mount one of the modular motion units. Although obscured by the base 100 and the splash guard 105, in this drawing, the modular motion unit is oriented so as to extend from the front of the base 100 to its rear and allows the carriage 102 to move along the Y-axis. A pair of upright legs 104, 108 are attached to the rear of the base 100 and support a horizontal beam 106.

Along the front of the horizontal beam 106 another modular motion unit 103 is attached and oriented such that its carriage (not shown in FIG. 1) travels between the two upright legs 104, 108. This axis of motion is orthogonal to the Y-axis and is considered the X-axis. Mounted on the carriage of the modular motion unit 103 is a support base 112 for the third modular motion unit 114. While the support base 112 travels along the X-axis, the modular motion unit 114 is oriented vertically, so that its carriage 116 travels along the Z-axis.

In operation, a work surface, such as a circuit board (not shown), is attached to the carriage 102 thereby being positioned within the robot, or positioner unit, 101. A tool (not shown), such as a solder dispenser, is mounted on the carriage 116 of the modular motion unit 114. Under supervision of a computer controlled-algorithm, for example, the work surface (e.g., the circuit board) and the tool (e.g., the solder dispenser) are moved using the three modular motion units so that solder can be applied at appropriate locations on the circuit board. In addition to solder dispensing, the positioner unit 101 may be used in a variety of manners, such as, for example, epoxy dispensing, flux dispensing, and other tools in addition to dispensing tools.

Computer control of robots and programming tool-control routines in automated equipment are well understood by one of ordinary skill in this field. The provision of appropriate computers, controllers, motors, encoders and their interconnection to accomplish accurate and repeatable motor control can be accomplished according to conventional techniques and procedures.

FIG. 2 depicts the three modular motion units without the presence of the frame legs 104, 108, splash guard 105, and base 100. The extruded frame 203 of the Y-axis unit 202 is shown with its carriage 102, a linear guide 204, and a motor 206. Similarly, the X-axis unit 103 and the Z-axis unit 114 are depicted as well. The X-axis unit 103 has its own linear guide 214 and motor 216 attached to its frame 215 as well. Similarly, the Z-axis unit 114 includes a separate motor 226, linear guide 224 and carriage 116.

In particular, FIG. 2 illustrates that the modular motion unit 202, for example, is designed such that it is not directly connected to another modular motion unit 103, 114. Thus, a drive cable of the modular motion unit 202 is not directly connected to any portion of the positioner device 101 that moves in one of the other axes of motion. Similarly, the respective drive cables of the other modular motion units 103, 114 also are not directly connected with some other portion of the positioner device 101 that moves along a different axis of motion.

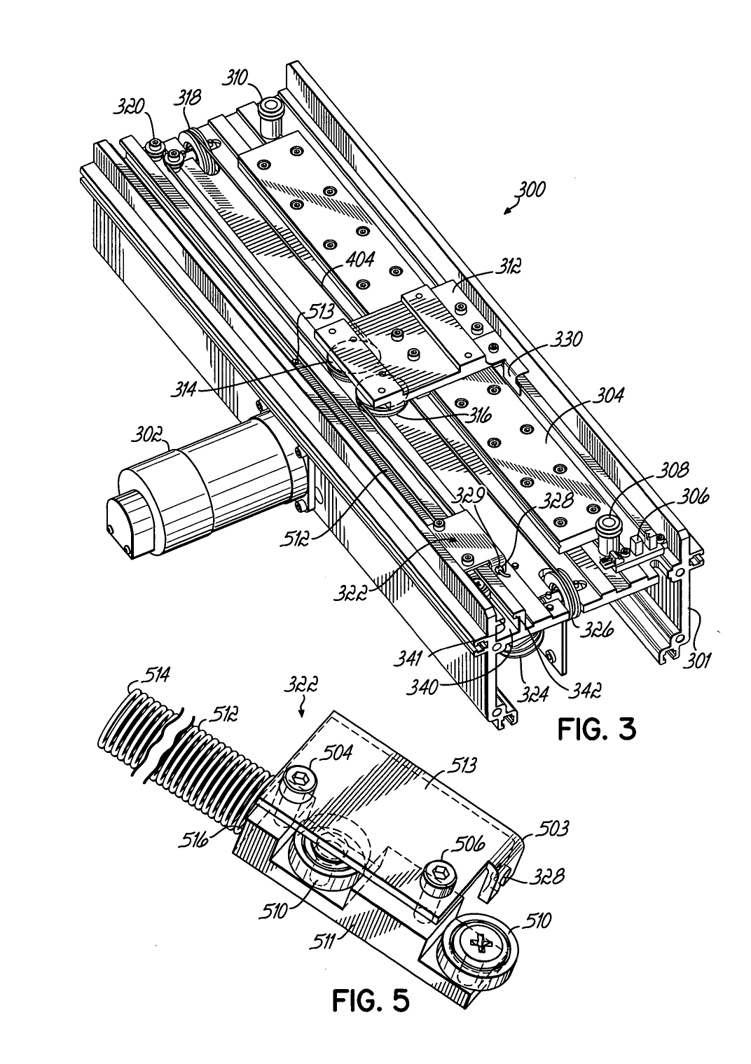

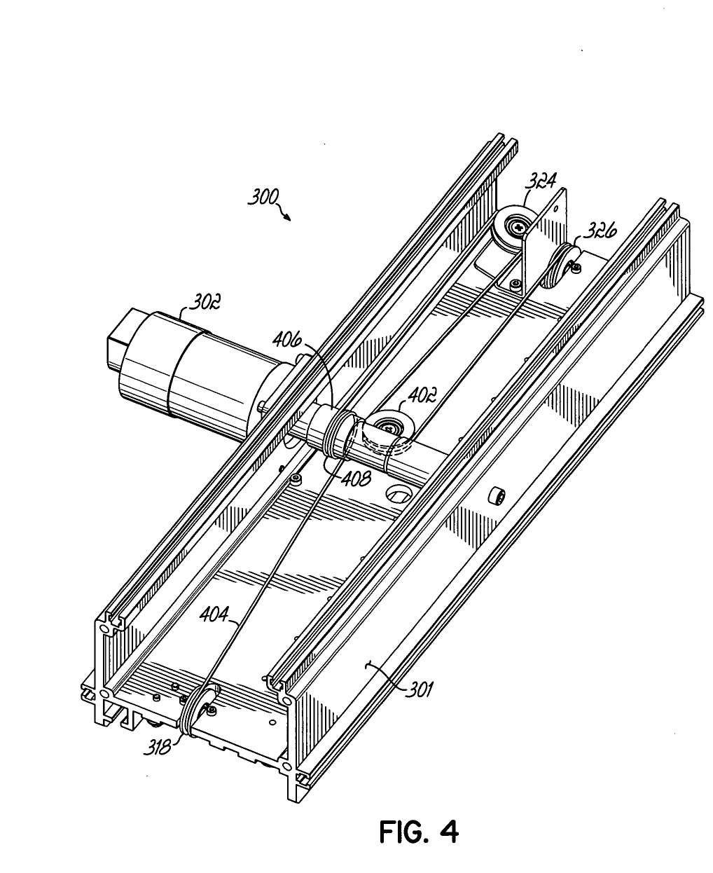

FIGS. 3 and 4 depict a more detailed view of any of the modular motion units (103, 114, 202) according to one embodiment of the present invention. For convenience, FIG. 3 will be described as a top view and FIG. 4 as a bottom view. However, in practice, each modular motion unit can be oriented in any manner and the terms “top” and “bottom” or other terms of spatial orientation used herein should not be viewed as limiting.

In FIG. 3, an extruded metal frame 301 is shown which provides the underlying base structure, or framework, for the modular motion unit 300. On this base structure, a motor 302 is attached that is under computer control to effect motion of the carriage 312. The carriage 312 rides along a linear guide 304 that is also attached to the underlying extruded frame 301. In general, linear guides and carriages are known and one of ordinary skill will readily appreciate that through the use of appropriate devices such as, for example, ball-bearings and guide tracks, motion of the carriage 312 can be limited to linear motion along the major axis of the linear guide 304.

Along each end of the linear guide 304, there is a bumper 308, 310 to stop and/or cushion the travel of the carriage 312. A “home switch” 306 is shown near the bumper 308; the switch 306 interacts with the flange 330 to detect when the carriage 312 is positioned in a known or “home” position. A number of pulleys 314, 316, 318, 326 and 324 define the travel path of a drive cable 404 which moves the carriage 312. A tensioner unit 322, described in more detail later, and a cable tie-off 320 define the starting and endpoints of the drive cable 404. The tensioner 322 operationally engages the channel 340 which, in this exemplary embodiment, is C-shaped.

The drive cable 404, which may advantageously be a nylon-coated, multi-strand steel cable, has a ball 329 at one end that engages a hole 328 of the tensioner 322. The cable 404 is held in position by the ball 329 and travels to and around the pulley 316 and then back towards the pulley 326. From underneath the unit 300, the cable 404 re-emerges at the pulley 318 and travels towards and around the pulley 314. The cable 404 ends at the tie-off area 320 that can be two screws over which the cable 404 is arranged as a figure-eight and the screws tightened.

From the bottom view of FIG. 4, the path of the cable 404 can be seen to start at the pulley 326, travel to the pulley 402, return towards the pulley 324, and then wrap around the motor-driven spool 406. The cable 404 leaves the spool 406 and then travels to the pulley 318. The number of wraps 408 around the spool 406 depends on the amount of travel permitted by the modular motion unit 300. For example, a wrap 408 of eleven turns would be sufficient to allow motion unit 300 to have a carriage 312 that travels approximately seventeen inches, assuming that a 1/16 inch cable 404 is used to wrap around a one inch spool 406 in which there is a 2:1 drive ratio such that one inch of cable 404 leaving the spool 406 causes the carriage 312 to move ½ inch. A skilled artisan would readily recognize that other cable sizes, spool sizes, number of turns, and drive ratios may be selected to provide a variety of different modular motion units without departing from the scope of the present invention.

The pulleys and pulley paths are arranged to minimize wear on the cable 404. For example, if a cable 404 having a 1/16 inch diameter is used, then a pulley (e.g. 402) having a diameter of approximately fifteen times this size or more will decrease the bend angle on the cable 404 as it travels around the pulley 402 and, thereby, reduce stress on the cable 404. Also, maximizing the distance between pulleys, such as between pulleys 402, 324, and 326 (see FIG. 4) reduces stress on the cable 404 as well. The greater the distance between pulleys, the less the cable 404 must flex when entering or leaving a pulley. Additionally, when appropriate, pulleys are arranged so that the cable 404 travels in a single plane. For example, the pulleys 314 and 318, and 316 and 326 are positioned such that the cable 404 travels substantially in a horizontal plane.

Even when the path of the cable 404 is controlled as described above, the stress and forces on the cable 404 can cause its tension to change over time. Because the programmed routines of the computerized controls of the positioner unit 101 assume the cable 404 of a motion unit (e.g., 300) is under a particular tension, routine maintenance on the cable 404 is typically performed to adjust its tension. Historically, re-tensioning a cable has required special tools and training to ensure proper adjustment. In contrast, embodiments of the present invention include a tensioner 322 arranged within the cable path that can be used to re-tension the cable 404 without special tools or training.

FIG. 5 depicts a more detailed view of the tensioner 322. The tensioner 322 includes a flange 503 having a hole that engages the ball-end 329 of the cable 404 (as shown in FIG. 3). As previously mentioned, the tensioner 322 rides in the channel 340 that has roughly a C-shaped cross-sectional profile. If the tensioner 322 moves away from the motor 302 in FIG. 3, then the drive cable 404 gets tighter and, conversely, if the tensioner 322 moves towards the motor 302, then the cable 404 becomes more slack. The exemplary tensioner 322 of FIG. 5 is constructed of two pieces that sandwich the two upper flanges 341, 342 of the channel 340. In operation the top piece 513 of the tensioner 322 sits above the channel 340 and the bottom piece 511 of the tensioner 322 sits within the channel 340. By way of the two screws 504, 506 the two pieces 511, 513 of the tensioner 322 are tightened together (or loosened). When the screws 504, 506 are tightened, the tensioner 322 pinches the upper flanges 341, 342 such that the tensioner 322 cannot move. By loosening the screws 504, 506, the tensioner 322 is free to move along the channel 340. To assist in this movement, and to keep the tensioner 322 from becoming cocked, or angled, within the channel 340, one or more ball bearings 510 can be attached to the bottom piece 511 of the tensioner 322 to act as a guide and to reduce friction.

A spring 512 is attached to the tensioner 322 such that the spring 512 is under compression and imparts a force on the tensioner 322. This spring 512 has one end 514 that cannot move relative to the drive cable and another end 516 that is in contact with the tensioner 322. For example, the spring 512 is positioned within the channel 340 with a stop 513 that prevents the end 514 from moving. The other end 516 engages the tensioner 322 simply by contacting the tensioner 322 or by being fixedly attached to the tensioner 322. When the screws 504, 506 are loose, the spring 512 acts to move the tensioner 322 away from the end 514, thereby tensioning the drive cable 404. Once the tensioner 322 no longer moves, the screws 504, 506 are tightened to hold the tensioner 322 in place. Thus, an untrained operator can accurately re-tension the drive cable 404 without special tools or training.

The nylon-coated, steel cables often used in motor-driven motion units in accordance with embodiments of the present invention are typically operated at approximately 10 pounds of tension which correlates to moving a slack cable 404 of this type approximately 1/10 inch. A 5 to 8 inch spring 512 having a spring rate of approximately 1.5 pounds/inch will readily accomplish uniform tensioning of the cable 404 for the expected mechanical lifetime of the modular motion unit 300.

While some embodiments of the present invention may use various drive mechanisms to move a carriage (e.g., 312), using a cable drive has a number of advantages. Instead of requiring a specific length ball screw, lead screw, rack and pinion, or belt for a given travel length, cable can be bought in bulk and cut to size. Additionally, cable has advantages over traditional drive elements such a ball and lead screws that have high inertia which requires a bigger motor and power source to move the same loads as a cable. Also, rack and pinion and both types of screws are difficult to align; belts are typically made of highly elastic materials that creep in time and slide on their drive sprockets thus being inaccurate both statically and dynamically.

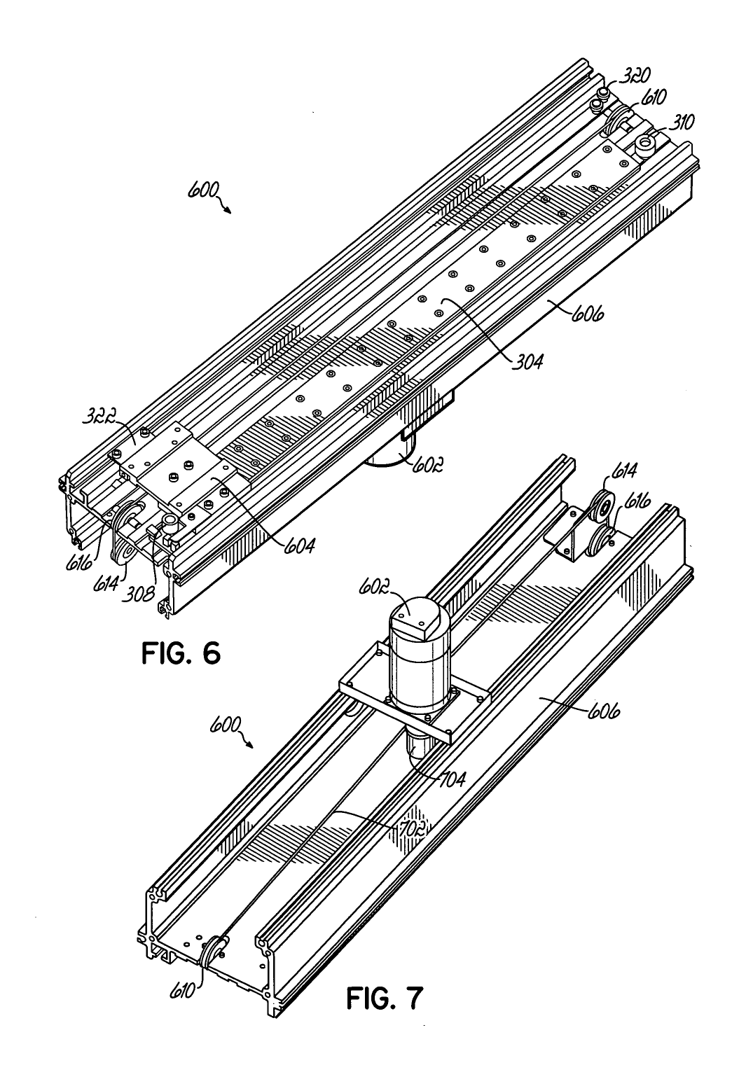

FIGS. 3 and 4 illustrate an exemplary modular motion unit 300; however, the location of the linear guide 304, the motor 302 and the various pulleys can be modified without departing from the scope of the present invention. For example, FIGS. 6 and 7 depict a top and bottom view of a modular motion unit 600 having the motor 602 located opposite the carriage 604. Because the extruded base structure 606 of a modular motion unit 600 is used to attach the unit to an underlying robot framework, it is beneficial to have alternative motor and carriage arrangements to address potential space limitations that might be encountered at a particular work area.

Similar numbers in FIGS. 6 and 7 reference similar elements in earlier figures. Other than the motor placement, the modular motion unit 600 of FIGS. 6 and 7 is substantially similar in structure to earlier described embodiment. In particular, there is an extruded base structure 606 having a linear guide 304 over which the carriage 604 travels between the bumpers 308, 310. Because of the different location of the motor 602 and spool 704, the pulleys 610, 614, 616 are arranged differently to provide an appropriate path for the drive cable 702. In this alternative configuration the path for the drive cable 702 is designed while accounting for the concerns expressed earlier relating to cable maintenance and longevity. Similarly, the tensioner unit 322 may also be present in order to provide a way for an untrained operator to properly retention the drive cable 702.

While the invention has been illustrated by the description of certain embodiments and while these embodiments have been described in considerable detail, there is no intention to restrict nor in any way limit the scope of the appended claims to such detail. Additional advantages and modifications will readily appear to those Who are skilled in the art.

Therefore, the invention in its broadest aspects is not limited to the specific details shown and described. Consequently, departures may be made from the details described herein without departing from the spirit and scope of the claims which follow.

1. A cable-drive modular motion unit for effecting one axis of motion of a multi-axis positioning device, comprising:
a base structure;
a linear guide attached to said base structure, said linear guide having a major axis aligned with said one axis of motion;
a carriage arranged on said linear guide such that motion of said carriage is limited to being along said major axis;
a drive motor attached to said base structure; and
a cable attached to said carriage and said drive motor such that rotation of said drive motor causes movement of said carriage, wherein, during operation of said multi-axis positioning device, said cable moves independently of any portion of said multi-axis positioning device that moves in an axis of motion other than said one axis of motion.

2. The cable-drive modular motion unit of claim 1, further comprising:
a linear channel along which a tensioner plate travels;
said tensioner plate attached with one end of said cable wherein movement in a first direction increases tension on said cable and movement in a second direction decreases tension on said cable;
a spring having a first fixed end and a second end operationally coupled with said tensioner plate, said spring being compressed so as to exert a force in said first direction; and
a releasable lock attached to said tensioner plate and configured, in a first position, to prevent said tensioner plate from moving and, in a second position, to permit said tensioner plate to move; whereby when said releasable lock is in said second position, said spring effects movement of said tensioner plate in said first direction.

3. The cable-drive modular motion unit of claim 2, wherein said releasable lock is configured to be changed between said first and second positions with a conventional tool.

4. The cable-drive modular motion unit of claim 1, wherein said drive motor is located on said base structure opposite said carriage.

5. A positioning device, comprising:
a first modular motion unit, comprising:
a first base structure;
a first linear guide attached to said first base structure, said first linear guide having a first major axis aligned with a first axis of motion;
a first carriage arranged on said first linear guide such that motion of said first carriage is limited to being along said first major axis;
a first drive motor attached to said first base structure, and
a first cable attached to said first carriage and said first drive motor such that rotation of said first drive motor causes movement of said first carriage; and
a second modular motion unit, comprising:
a second base structure;
a second linear guide attached to said second base structure, said second linear guide having a second major axis aligned with a second axis of motion;
a second carriage arranged on said second linear guide such that motion of said second carriage is limited to being along said second major axis;
a second drive motor attached to said second base structure, and
a second cable attached to said second carriage and said second drive motor such that rotation of said second drive motor causes movement of said second carriage independent from movement of said first carriage.

6. The positioning device of claim 5, wherein said first axis of motion and said second axis of motion are substantially orthogonal to one another.

7. The positioning device of claim 5, further comprising:
a frame on which said first modular motion unit and said second modular motion unit are operatively coupled.

8. A tensioning device for a cable of a cable drive system, comprising:
a tensioner plate;
a linear channel along which said tensioner plate travels;
said tensioner plate configured for attachment with one end of said cable wherein movement of said tensioner plate in a first direction increases tension on said cable and movement in a second direction decreases tension on said cable;
a spring having a first fixed end and a second end operationally coupled with said tensioner plate, said spring being compressed so as to exert a force in said first direction; and
a releasable lock attached to said tensioner plate and configured, in a first position, to prevent said tensioner plate from moving and, in a second position, to permit said tensioner plate to move; whereby when said releasable lock is in said second position, said spring effects movement of said tensioner plate in said first direction.

9. The tensioning device of claim 8, wherein said releasable lock is configured to be changed between said first and second positions with a conventional tool.

10. The tensioning device of claim 8, further comprising:
a spring stop located at least partially within said linear channel adjacent to said first fixed end.

11. The tensioning device of claim 8, wherein said releasable lock comprises:
a first portion configured to be positioned outside of said linear channel;
a second portion configured to be positioned within said linear channel; and
a connector configured to releasably couple said first portion to said second portion.

12. The tensioning device of claim 11, wherein said second portion further includes one or more bearings configured to engage an inside of said linear channel.

13. A method for tensioning a cable of a cable drive system, comprising the steps of:
attaching one end of the cable to a movable tensioner plate, wherein movement in a first direction increases tension on the cable and movement in a second direction decreases tension on the cable;
locking the movable tensioner plate in a first fixed position;
arranging a spring against said movable tensioner plate such that a force of the spring acts on the movable tensioner plate in the first direction;
releasing the movable tensioner plate from the first fixed position thereby allowing the spring to move the movable tensioner plate, in the first direction, to a second position; and
locking the movable tensioner plate at the second position.

14. The method of claim 13, wherein the step of releasing further includes the step of:
using a conventional tool to release the movable tensioner plate.

15. The method of claim 13, wherein the step of locking the movable tensioner plate at the second position, further includes the step of:
using a conventional tool to lock the movable tensioner plate.

16. A method for providing movement in a multi-axis positioning device comprised of a plurality of modular motion units, the method comprising the steps of:
orienting, along a first axis of motion, a first modular motion unit on a frame, the first modular motion unit comprising a first motor, a first cable, and a first carriage operatively coupled together;
orienting, along a second axis of motion, a second modular motion unit on the frame, the second modular motion unit comprising a second motor, a second cable, and a second carriage operatively coupled together;
energizing the first motor so as to cause the first cable to move the first carriage along the first axis of motion; and
energizing the second motor so as to cause the second cable to move the second carriage along the second axis of motion, wherein the movement of the second carriage occurs independent from the movement of the first carriage.

17. The method of claim 16, wherein the first cable and the second cable are unconnected to one another.

18. The method of claim 16, further comprising the step of: arranging a third modular motion unit on the base structure to provide motion in a third axis, wherein the third modular motion unit operates independently of the first and second modular motion units.

19. The method of claim 16, wherein the first axis is substantially orthogonal to the second axis.
